(19) United States
(12) Patent Application Publication
(10) Pub. No.: US 2021/0295301 A1
(43) Pub. Date: Sep. 23, 2021

(54) ORDERING DEVICE AND ASSOCIATED METHOD OF USE

(71) Applicant: Charles S. Reid, Holland, MI (US)

(72) Inventor: Charles S. Reid, Holland, MI (US)

(21) Appl. No.: 17/096,105

(22) Filed: Nov. 12, 2020

Related U.S. Application Data
(60) Provisional application No. 62/934,838, filed on Nov. 13, 2019.

(51) Int. Cl. G06Q 20/32; G06Q 50/12

(52) U.S. Cl. CPC G06Q 20/322; G06Q 50/12

(57) ABSTRACT

An ordering device as provided herein having one or more of the disclosed structural, functional, and/or ornamental characteristics.

### CROSS-REFERENCE TO RELATED APPLICATIONS

This application claims the benefit of U.S. Provisional Application Ser. No. 62/934,838, entitled “ORDERING DEVICE AND ASSOCIATED METHOD OF USE,” filed Nov. 13, 2019—which is hereby incorporated herein by reference in its entirety, including all references cited therein.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to ordering devices, and more particularly, to ordering devices that can sit on top of a table or be inserted into the table providing wireless charging to multiple mobile phones, an e-paper display, and a near-field communication (NFC) transmitter. The ordering devices of the present invention incorporate a table positioning system (TPS) that locates tables in individual restaurants through the restaurant's mobile application. The ordering devices of the present invention sends the customer directly to their app from the table so nobody needs to stand in line anymore.

### 2. Background Art

Ordering devices have been known in the art for several years. While ordering devices have been known in the art, the ordering devices provided herein comprise one or more structural, functional, and/or ornamental characteristic(s) which are to the best of applicant's knowledge unique, novel, and non-obvious.

### SUMMARY OF THE INVENTION

The present invention is directed to one or more ordering devices herein having at least one of the disclosed structural, functional, and/or ornamental characteristics.

### DESCRIPTION OF THE DRAWINGS

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated.

The invention will now be described with reference to the drawings wherein, Appendix A shows a plurality of unique, novel, and non-obvious ordering devices having at least one of the disclosed structural, functional, and/or ornamental characteristics.

The foregoing description merely explains and illustrates the invention and the invention is not limited thereto except insofar as the appended claims are so limited, as those skilled in the art who have the disclosure before them will be able to make modifications without departing the scope of the invention.

What is claimed is:

1. An ordering device as provided herein having one or more of the disclosed structural, functional, and/or ornamental characteristics.

2. An ordering device as disclosed in Appendix A.
